(19) United States
(12) Patent Application Publication
(10) Pub. No.: US 2026/0132763 A1
(43) Pub. Date: May 14, 2026

(54) SYSTEMS AND METHODS TO PERFORM AN OVER THE AIR UPDATE ON A VEHICLE

(71) Applicant: Ford Global Technologies, LLC, Dearborn, MI (US)

(72) Inventors: Tyler Nicholas Rogers, Grosse Pointe Woods, MI (US); Aed M. Dudar, Canton, MI (US)

(73) Assignee: Ford Global Technologies, LLC, Dearborn, MI (US)

(21) Appl. No.: 18/946,492

(22) Filed: Nov. 13, 2024

(51) Int. Cl. F02N 11/08; B60R 16/033; G06F 8/65; G07C 5/10; H01M 10/42

(52) U.S. Cl. CPC F02N 11/08; B60R 16/033; G06F 8/65; G07C 5/10; H01M 10/425; F02N 2200/061; H01M 2220/20

(57) ABSTRACT

A vehicle including a battery, a memory and a processor is disclosed. The battery may provide power to the vehicle, and the memory may store historical vehicle information. The processor may determine that a software update may be available for the vehicle. Responsive to determining that the software update may be available, the processor may determine an optimal time to initiate a software update installation in the vehicle to optimize a battery usage, based on the historical vehicle information. The processor may further transmit an installation initiation notification to a server to install the software update at the optimal time.

### FIELD

The present disclosure relates to systems and methods to perform an over-the-air update on a vehicle at an optimal time to optimize vehicle battery usage.

### BACKGROUND

Most modern vehicles have a plurality of components and modules that require software updates over time. These updates may be required to fix bugs, upgrade existing software to newer versions, add new functionalities, and/or the like. The updates may be performed via a physical connection at a vehicle dealership facility, or may be performed remotely “over-the-air” (OTA) via a server. It is known that energy from a vehicle battery is consumed when the vehicle installs OTA updates or performs “OTA flashing”. A system and method is required to optimize the vehicle battery usage when the vehicle performs OTA flashing.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system to install an over-the-air (OTA) update on a vehicle in accordance with the present disclosure.

FIG. 3 depicts an example graph between ambient temperature and time in accordance with the present disclosure.

FIGS. 4A and 4B depict a flow diagram of an example method to install an OTA update on a vehicle in accordance with the present disclosure.

### DETAILED DESCRIPTION

### Overview

The present disclosure describes a vehicle that may optimize vehicle battery usage when the vehicle installs a software update or performs over-the-air (OTA) flashing. The vehicle may optimize the battery usage such that the battery may efficiently crank the vehicle engine when a vehicle user starts the vehicle, after the OTA flash is complete or the software is successfully updated.

It may be appreciated that a vehicle battery may drain power or experience a state of charge (SOC) drop when the vehicle performs the OTA flash. The battery may further drain power or experience SOC drop when the vehicle is parked in a cold ambient environment (and not in an enclosed space). The vehicle may perform one or more mitigation actions to ensure that the battery is effectively replenished or compensated for the SOC amount/value that is “lost” due to the OTA flash operation and the cold ambient environment, thereby enabling the battery to effectively crank the vehicle engine when the user starts the vehicle after the OTA flash.

In some aspects, the vehicle may first determine that a software update may be available on a server for the vehicle. Responsive to determining that the software update is available, the vehicle may determine an optimal time to perform the OTA flash or install the software update on the vehicle, based on historical vehicle usage information. In an exemplary aspect, the vehicle may determine the optimal time to perform the OTA flash to be within a time duration when a vehicle engine is expected to have residual heat from vehicle's travel cycle, a time duration when the vehicle is expected to be connected to a block heater, and/or a time duration when the vehicle is expected to be parked in an enclosed parking space (determined based on the historical vehicle usage pattern/information).

Responsive to determining the optimal time to perform the OTA flash, the vehicle may install and execute the software update on the vehicle at the determined optimal time. In some aspects, the vehicle may seek/obtain a confirmation from the user before installing the software update on the vehicle. Further, the vehicle may perform the OTA flash when the vehicle is keyed-off (i.e., when the vehicle engine is switched off).

The vehicle may further measure/estimate an SOC drop (or a “first SOC drop”) that the battery may experience due to the OTA flash. In some aspects, the vehicle may measure the first SOC drop based on inputs obtained from a vehicle control unit. In other aspects, the vehicle may estimate the first SOC drop based on a plurality of parameters including, but not limited to, an estimated time required to perform the OTA flash, an initial SOC of the battery before the OTA flash, battery health conditions, battery age, and/or the like. In an exemplary aspect, the estimated time required to perform the OTA flash may depend on a size of a software update file, a total count of vehicle components/modules for which the OTA flash is being performed, a transfer rate or a network strength associated with a wireless network connecting the vehicle and the server, and/or the like.

The vehicle may further estimate an expected vehicle start time based on the historical vehicle usage pattern. In some aspects, the expected vehicle start time may be a future time when the user may be expected to start the vehicle (e.g., to use/drive the vehicle). Responsive to estimating the expected vehicle start time, the vehicle may estimate an expected ambient temperature at the expected vehicle start time based on weather condition information (that the vehicle may obtain from the server or the cloud).

The vehicle may further estimate an SOC drop (or a “second SOC drop”) that the battery may experience at the expected vehicle start time due to cold weather conditions, when the vehicle is parked outside and/or when the first SOC drop is greater than a predefined SOC threshold. The vehicle may estimate the second SOC drop by correlating the expected ambient temperature with a table or a mapping between a plurality of SOC drop values with a plurality of ambient temperatures.

Responsive to determining/estimating the first SOC drop and the second SOC drop as described above, the vehicle may auto-start the vehicle engine to charge the vehicle battery by an SOC value/amount that may be equivalent to a sum of the first SOC drop and the second SOC drop, after the OTA flash operation is complete. The vehicle may switch off the vehicle engine when the battery gets charged or compensated by the SOC value/amount described above. In this manner, the vehicle ensures that the battery has enough SOC to crank the vehicle engine, when the user starts the vehicle at the expected vehicle start time.

The present disclosure discloses a vehicle that may install and execute a software update at an optimal time, such that the vehicle battery usage is optimized. The vehicle may further auto-start the vehicle engine post-OTA flash, to compensate for the SOC drop caused due to OTA flashing and the SOC drop that the battery is expected to experience due to cold ambient weather conditions. These mitigation actions/steps may facilitate the battery to effectively crank the vehicle engine, when the user starts the vehicle post-OTA flash.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

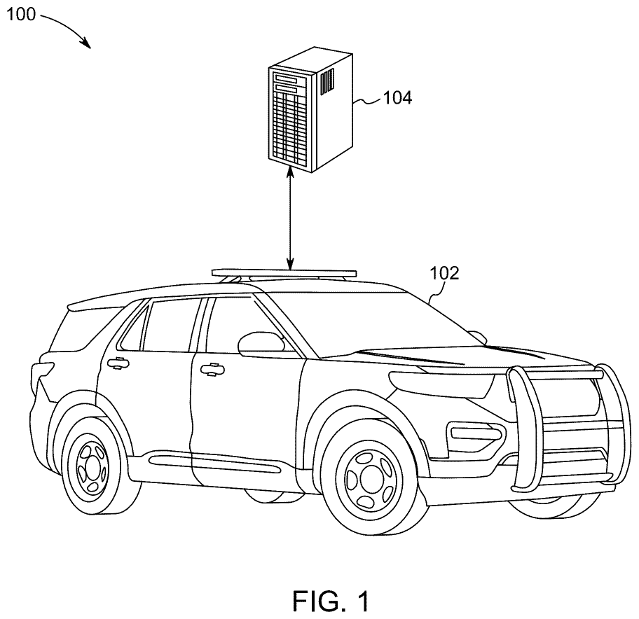

FIG. 1 depicts an environment 100 in which techniques and structures for providing the systems and methods disclosed herein may be implemented. The environment 100 may include a vehicle 102 and a server 104 (or a remote computing device) that may communicatively couple with each other. The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. Further, the vehicle 102 may include any powertrain, such as a gasoline engine or a hybrid system.

The vehicle 102 may include a plurality of components/modules that may require software updates over time. Examples of such components/modules include, but are not limited to, a powertrain system, a chassis system, an advanced driver assistance system (ADAS), an infotainment system, and/or the like. The updates may be required to upgrade existing systems to newer versions, fix bugs, add new features/functionalities, etc.

The vehicle 102 may obtain/download a software update file remotely (or “over-the-air” (OTA)) from the server 202, and may install and execute the software update file to perform the software update for the vehicle components/modules. In the present disclosure, the steps of obtaining, installing and executing the software update file in the vehicle 102 are collectively referred to as performing an “OTA update” or “OTA flash” (or OTA flashing).

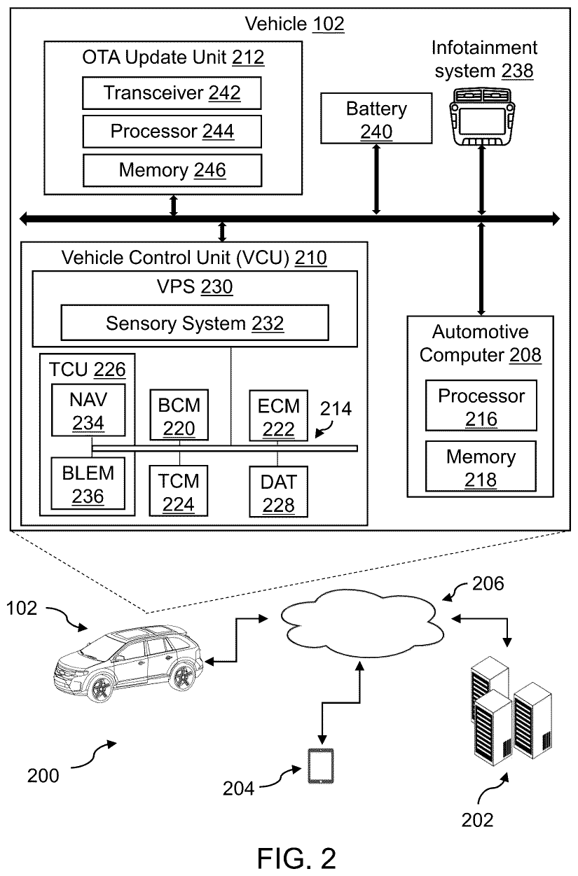

In some aspects, the vehicle 102 may consume energy from a vehicle battery (shown as battery 240 in FIG. 2) when the vehicle 102 performs the OTA flash. The amount of energy that the vehicle 102 may consume while performing the OTA flash may depend on a plurality of parameters including, but not limited to, an estimated time required to perform the OTA flash, an initial state of charge (SOC) of the vehicle battery before the OTA flash, battery health conditions, battery age, and/or the like. In an exemplary aspect, the estimated time required to perform the OTA flash may depend on a size of the software update file, a total count of vehicle components/modules for which the OTA flash is being performed, a transfer rate or a network strength associated with a wireless network connecting the vehicle 102 and the server 104, and/or the like.

While smaller/shorter software updates may not consume much battery energy, the software updates that are larger in size or that require greater installation time may consume substantial battery energy and hence main drain the vehicle battery. This may result in considerable SOC drop for the vehicle battery.

The vehicle 102 typically performs the OTA flash in a key-off mode, i.e., when a vehicle engine is switched OFF. Therefore, if there is considerable SOC drop for the vehicle battery due to OTA flashing, there may be a scenario where a vehicle user (not shown) may not be able to crank or start the vehicle engine when the user desires to start and drive/use the vehicle 102 after the vehicle 102 performs the OTA flash. The probability of occurrence of such a scenario may further increase if the vehicle 102 is located in a geographical area having a cold ambient temperature (and if the vehicle 102 is not parked in an enclosed space). It is known that the vehicle battery uses more electric energy (or current) to crank or start a “cold” vehicle engine as compared to a vehicle engine that is relatively warmer. Therefore, if the vehicle 102 is located in a cold ambient environment, the vehicle battery may experience power drop, which may result in further drop in the battery SOC.

The combined drop in the battery SOC due to OTA flashing and the cold ambient environment may adversely affect the probability of a successful crank or start of the vehicle engine (when the user requires to start the vehicle 102). To ensure that the user is able to successfully crank or start the vehicle engine after the OTA flash is complete, the vehicle 102 may perform one or more pre and post OTA flash mitigation actions, as described briefly below and described in detail later in conjunction with FIG. 2.

The vehicle 102 may first determine that an OTA update or a new software update may be available on the server 104 to be installed on the vehicle 102. Responsive to such determination, the vehicle 102 may determine an “optimal” time to perform the OTA flash based on historical vehicle information or historical vehicle usage pattern/information (that may be stored in a vehicle memory and/or the server 104). In an exemplary aspect, the historical vehicle information may include information associated with time durations when the vehicle user typically drives the vehicle 102, the time durations when the vehicle engine likely has “residual” heat after the vehicle's drive cycles (e.g., when the vehicle 102 returns home after long drive cycles), the time durations when the vehicle 102 is likely connected to a block heater, the time durations when the vehicle 102 is likely parked in an enclosed space (e.g., in a closed garage), etc.

In some aspects, the vehicle 102 may determine the optimal time to perform the OTA flash to be within any of the time durations described above. It may be appreciated that the time durations described above are those time durations when the vehicle engine may be warmer than the ambient temperature. The vehicle 102 may choose the optimal time to be within these time durations as the vehicle battery may not have to consume considerable additional energy to crank or start the vehicle engine post-OTA flashing, if the vehicle engine is warm (as compared to a time when the vehicle engine is cold or the vehicle 102 is parked outside in cold ambient temperature).

In some aspects, responsive to determining the optimal time to perform the OTA flash as described above, the vehicle 102 may transmit a confirmation notification to a user device (shown as user device 204 in FIG. 2) associated with the vehicle user. The confirmation notification may include information associated with the determined optimal time, so that the user may confirm whether the user accepts or refuses the OTA flashing to be performed at the determined optimal time. The vehicle 102 may perform the OTA flash at the determined optimal time when the user transmits a confirmation response via the user device. Alternatively, the user may propose a different time for the OTA flash when the user does not accept the determined optimal time (e.g., if the user has plans to use/drive the vehicle 102 at the determined optimal time). In alternative aspects, the vehicle 102 may skip this step of seeking the user confirmation, and may directly perform the OTA flash at the determined optimal time.

At the optimal time, the vehicle 102 may download, install and execute the software update file to perform the software update or the OTA flash in the vehicle 102. After the OTA flash is complete, the vehicle 102 may perform one or more post-OTA mitigation actions/steps to optimize battery usage, as described below.

Responsive to determining that the OTA flash is complete or the software update is successful, the vehicle 102 may measure/estimate a drop in vehicle battery SOC (e.g., a “first SOC drop”) due to the OTA flash. Stated another way, responsive to determining that the OTA flash is complete, the vehicle 102 may determine the battery energy or SOC that may have been drained or consumed to perform the OTA flash. In some aspects, the vehicle 102 may measure the first SOC drop directly based on inputs obtained from a vehicle control unit (shown as VCU 210 in FIG. 2). In this case, the vehicle 102 may first determine an initial battery SOC level before performing the OTA flash (i.e., pre-OTA battery SOC level) and then determine a real-time battery SOC level after the OTA flash is complete (i.e., post-OTA battery SOC level), based on the inputs obtained from the VCU. The vehicle 102 may determine the first SOC drop as a difference between the post and pre OTA battery SOC levels.

In other aspects, the vehicle 102 may estimate the first SOC drop based on the parameters described above. For example, the vehicle 102 may estimate the first SOC drop based on parameters such as the estimated time required to perform the OTA flash, the initial SOC level of the vehicle battery before the OTA flash, the battery health conditions, the battery age, and/or the like.

Responsive to determining the first SOC drop as described above, in some aspects, the vehicle 102 may compare the first SOC drop with a predefined SOC drop threshold. The vehicle 102 may perform one or more post-OTA mitigation actions/steps when the vehicle 102 determines that the first SOC drop is greater than the predefined SOC drop threshold. Stated another way, the vehicle 102 may perform one or more post-OTA mitigation actions when the vehicle battery may have experienced a substantial drop/drain in energy/SOC level. In other aspects, the vehicle 102 may skip this comparison step, and may perform one or more post-OTA mitigation actions irrespective of whether the first SOC drop is greater or less than the predefined SOC drop threshold.

As part of the post-OTA mitigation actions, the vehicle 102 may first determine an expected vehicle engine start time based on a historical vehicle usage pattern (that may be part of the historical vehicle information described above). Specifically, in this case, the vehicle 102 may determine an estimated future time when the vehicle user is expected to crank or start the vehicle engine, e.g., to drive or use the vehicle 102, based on the historical vehicle usage pattern. In additional or alternative aspects, the vehicle 102 may determine the expected vehicle engine start time based on pre-programmed trip start time that the vehicle user may have provided to the vehicle 102 in advance. For example, if the user has provided an input to the vehicle 102 (e.g., to the vehicle's onboard computer) indicating that the user will start a trip at 7 AM, the vehicle 102 may determine the expected vehicle engine start time as 7 AM. In this case, the vehicle 102 may also customize/optimize the vehicle's cabin temperature/climate before the scheduled trip start time (i.e., by 7 AM).

Responsive to determining the expected vehicle engine start time, the vehicle 102 may determine an estimated ambient temperature at the expected vehicle engine start time based on weather condition information that the vehicle 102 may obtain from the server 202 or the cloud.

The vehicle 102 may further estimate an expected SOC drop (or a “second SOC drop”) in the vehicle battery due to ambient temperature at the expected vehicle engine start time, based on a mapping between a plurality of SOC drop values/levels and a plurality of different ambient temperatures. In some aspects, this mapping may be pre-stored in the vehicle memory and/or the server 104. Responsive to estimating the second SOC drop, the vehicle 102 may switch ON or crank the vehicle engine within a predetermined time duration of the OTA flash completion (when the vehicle engine may still be warm due to the vehicle's drive cycle or due to the vehicle's connection to the block heater), and cause the vehicle battery to charge to replenish the first and second SOC drops. The vehicle 102 may keep the vehicle engine in the ON state till the vehicle battery gets charged to an SOC level/value equivalent to a sum of the first and second SOC drops. Thereafter, the vehicle 102 may switch OFF the vehicle engine.

By causing the vehicle battery to get recharged to compensate for the first and second SOC drops post OTA completion, the vehicle 102 ensures that by the time the vehicle user starts the vehicle engine at the expected vehicle engine start time (when the ambient temperature and the vehicle engine may be cold), the vehicle battery has enough SOC to successfully crank the vehicle engine. In this manner, the vehicle 102 compensates for the battery drain (or loss of SOC) due to the OTA flash operation and the cold ambient conditions, and thus facilitates in considerably reducing the probability of an unsuccessful vehicle crank after the OTA flash operation.

Further vehicle 102 details are described below in conjunction with FIG. 2.

The vehicle 102 implements and/or performs operations, as described here in the present disclosure, in accordance with the owner manual and safety guidelines. In addition, any action taken by the vehicle user based on the notifications provided by the vehicle 102 should comply with all the rules specific to the location and operation of the vehicle 102 (e.g., Federal, state, country, city, etc.). The notifications, as provided by the vehicle 102, should be treated as suggestions and only followed according to any rules specific to the location and operation of the vehicle 102.

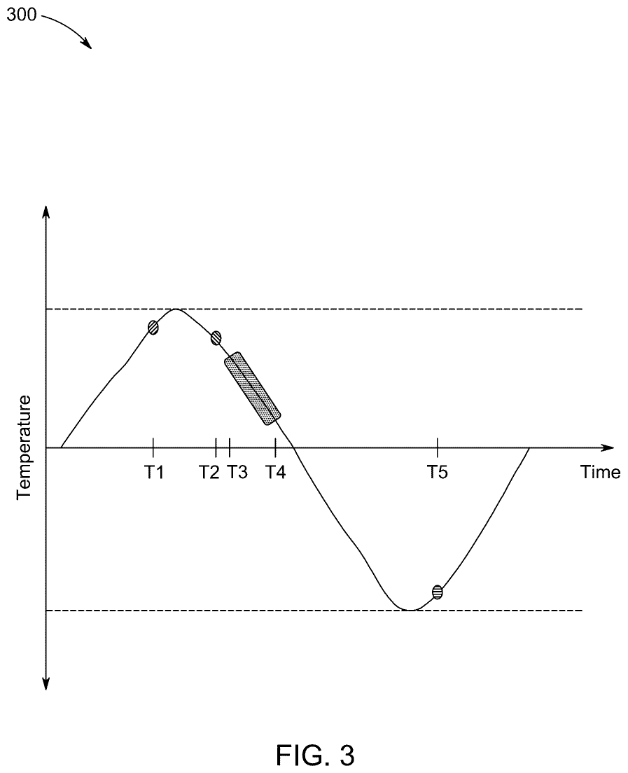

FIG. 2 depicts a block diagram of a system 200 to install an over-the-air (OTA) update on the vehicle 102 in accordance with the present disclosure. While describing FIG. 2, references will be made to FIG. 3.

The system 200 may include the vehicle 102, one or more servers 202 (or a server 202, which may be same as the server 104 described above) and a user device 204 communicatively coupled with each other via one or more networks 206. The user device 204 may be associated with the vehicle user and may be, for example, a mobile phone, a laptop, a tablet, a smartwatch, or any other similar device with communication capabilities. The server 202 may be part of a cloud-based computing infrastructure and may be associated with and/or include a Telematics Service Delivery Network (SDN) that provides digital data services to the vehicle 102 and other vehicles (not shown in FIG. 2) that may be part of a vehicle fleet.

In further aspects, the server 202 may store historical vehicle information associated with the vehicle 102, and may transmit the historical vehicle information to the vehicle 102 at a predefined frequency or when the vehicle 102 requests to receive such information. The historical vehicle information may include, for example, information associated with vehicle's travel and usage patterns, information associated with time durations when the vehicle user likely (that is, typically based on historical data) drives the vehicle 102, information associated with time durations when the vehicle engine likely (that is, typically based on historical data) has residual heat from vehicle's travel cycles, information associated with time durations when the vehicle 102 is likely (that is, typically based on historical data) connected with a block heater, information associated with time durations when the vehicle 102 is likely (that is typically based on historical data) parked in an enclosed parking space, and/or the like, as described above in conjunction with FIG. 1.

The server 202 may further store a mapping of a plurality of battery SOC drop values or power drain values with a plurality of ambient temperatures. For example, the server 202 may store a mapping or table that shows that the vehicle battery typically has an effective SOC drop or power drop of 0% when the ambient temperature (at a location where the vehicle 102 is located) is 80 degrees Fahrenheit, 15% when the ambient temperature is 60 degrees Fahrenheit, 30% when the ambient temperature is 40 degrees Fahrenheit, 35% when the ambient temperature is 32 degrees Fahrenheit, 60% when the ambient temperature is 0 degree Fahrenheit, 75% when the ambient temperature is −20 degrees Fahrenheit, and/or the like. The server 202 may transmit this mapping/table to the vehicle 102 at a predefined frequency or when the vehicle 102 requests to receive the mapping.

The server 202 may additionally store a software update file when a software update may be available for the vehicle 102. In some aspects, a vehicle manufacturer may provide the software update file to the server 202, whenever the software update may be available for one or more vehicle components or modules. The server 202 may transmit the software update file to the vehicle 102 (for execution on the vehicle 102) when the server 202 receives an installation initiation notification from the vehicle 102.

The network(s) 206 illustrates an example communication infrastructure in which the connected devices discussed in various embodiments of this disclosure may communicate. The network(s) 206 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 102 may include a plurality of units including, but not limited to, an automotive computer 208, a Vehicle Control Unit (VCU) 210, and an OTA update unit 212 (or unit 212). The VCU 210 may include a plurality of Electronic Control Units (ECUs) 214 in communication with the automotive computer 208.

In some aspects, the automotive computer 208 and/or the unit 212 may be installed anywhere in the vehicle 102, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be in communication with one or more memory devices in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing an OTA update program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle 102 systems, connected servers (e.g., the server(s) 202), and other vehicles (not shown in FIG. 2) operating as part of a vehicle fleet. The VCU 210 may include or communicate with any combination of the ECUs 214, such as a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc.

The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a radio detection and ranging (radar) sensor configured for detection and localization of objects inside and outside the vehicle 102 using radio waves, sitting area buckle sensors, sitting area sensors, a light detecting and ranging (lidar) sensor, door sensors, proximity sensors, temperature sensors, wheel sensors, ambient weather sensors, ambient light sensors, vehicle internal and external cameras, one or more rain sensors, a humidity sensor, a tire pressure sensor, ultrasonic sensors, etc. In some aspects, the vehicle sensory system 232 may measure a vehicle engine coolant temperature at a predefined frequency.

In some aspects, the VCU 210 may control vehicle operational aspects and implement one or more instruction sets received from the user device 204, from one or more instruction sets stored in the memory 218, including instructions operational as part of the unit 212.

The TCU 226 may be configured and/or programmed to provide vehicle connectivity to wireless computing systems onboard and off board the vehicle 102 and may include a Navigation (NAV) receiver 234 for receiving and processing a GPS signal, a BLE Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., the user device 204, a key fob, an NFC device, etc.), computers, and modules. The NAV receiver 234 may be configured to determine a real-time vehicle geolocation. The TCU 226 may be in communication with the ECUs 214 by way of a bus.

The ECUs 214 may control aspects of vehicle operation and communication using inputs from human drivers, inputs from an autonomous vehicle controller, the unit 212, and/or via wireless signal inputs received via the wireless connection(s) from other connected devices, such as the user device 204, the server(s) 202, among others.

The BCM 220 generally includes integration of sensors, vehicle performance indicators, and variable reactors associated with vehicle systems and may include processor-based power distribution circuitry that can control functions associated with the vehicle body such as lights, windows, security, camera(s), fan, headlights, audio system(s), speakers, wipers, door locks and access control, mirrors, various comfort controls, enclosures, and/or the like. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI) 238). The infotainment system 238 may include a touchscreen interface portion and may include voice recognition features, biometric identification capabilities that can identify users based on facial recognition, voice recognition, fingerprint identification, or other biological identification means. In other aspects, the infotainment system 238 may further receive user instructions/inputs via the touchscreen interface portion and/or display notifications/recommendations, navigation maps, etc. on the touchscreen interface portion.

The vehicle 102 may further include a battery 240 that may provide power to one or more vehicle components. In some aspects, the battery 240 may provide power/energy to crank the vehicle engine, when the vehicle engine is started from an idle or OFF state.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 102, may include a transceiver 242, a processor 244, and a computer-readable memory 246.

The transceiver 242 may receive information/inputs from one or more external devices or systems, e.g., the user device 204, the server(s) 202, and/or the like via the network 206. For example, the transceiver 242 may receive the historical vehicle information, the mapping of a plurality of battery SOC drop values with a plurality of ambient temperatures, the software update file, and/or the like from the server 202 via the network 206. Further, the transceiver 242 may transmit notifications to the external devices or systems. In addition, the transceiver 242 may receive information/inputs from vehicle 102 components such as the infotainment system 238, the VCU 210, and/or the like. Further, the transceiver 242 may transmit notifications/command signals to the vehicle 102 components such as the VCU 210, the vehicle engine, the infotainment system 238, etc.

The processor 244 and the memory 246 may be the same as or similar to the processor 216 and the memory 218, respectively. In some aspects, the processor 244 may utilize the memory 246 to store programs in code and/or to store data for performing aspects in accordance with the disclosure. The memory 246 may be a non-transitory computer-readable medium or memory storing the OTA update program code. In some aspects, the memory 246 may store the historical vehicle information, the mapping of a plurality of battery SOC drop values with a plurality of ambient temperatures, and the software update file, which the vehicle 102 obtains from the server 202.

In operation, the processor 244 may first determine that the software update may be available on the server 202 for the vehicle 102. In some aspects, the processor 244 may determine that the software update may be available on the server 202 based on an update availability notification that the vehicle 102 may receive from the server 202, when the server 202 has the software update for the vehicle 102. Responsive to determining that the software update may be available for the vehicle 102, the processor 244 may determine an optimal time to initiate a software update installation in the vehicle 102 to optimize the battery 240 usage based on the historical vehicle information (that may be stored in the memory 246, as described above).

As an example, by using the historical vehicle information (specifically, the historical vehicle usage pattern), the processor 244 may determine the optimal time as a time when the vehicle engine is expected to have residual “waste” heat from a prior vehicle's drive cycle. For example, if the vehicle 102 is expected to arrive at the user's home after a long drive at 6 PM (determined based on the historical vehicle information/vehicle usage pattern), the processor 244 may determine the optimal time to initiate the software update installation as 6:10 PM or 6:15 PM, when the vehicle engine may still be “warm” from the vehicle's drive cycle. Choosing such a time to perform the software update installation or OTA flash facilitates the processor 244 to efficiently perform the post-OTA mitigation actions/steps, which are described later in the description below.

As another example, by using the historical vehicle information, the processor 244 may determine the optimal time as a time when the vehicle user is expected to connect the vehicle 102 to a block heater (which may cause the vehicle engine to get warm). In further aspects, the processor 244 may obtain inputs from the vehicle sensory system 232, and monitor a real-time vehicle engine coolant temperature based on the inputs obtained from the vehicle sensory system 232 (e.g., when the vehicle 102 may be connected to the block heater). The processor 244 may further compare the real-time vehicle engine coolant temperature with a predefined coolant temperature threshold, and determine the optimal time to initiate the software update installation/OTA flash as a time when the vehicle engine coolant temperature becomes greater than the predefined coolant temperature threshold. Stated another way, in this case, the processor 244 may determine the optimal time as a time when the vehicle engine becomes warm.

As yet another example, by using the historical vehicle information, the processor 244 may determine the optimal time as a time when the vehicle 102 may be parked in an enclosed space (e.g., an enclosed parking structure, garage, etc.) where the temperature may be warmer than the ambient temperature outside (which may cause the vehicle engine to stay relatively warm).

In some aspects, if the processor 244 is unable to determine the optimal time by using the historical vehicle information as described above, the processor 244 may transmit, via the transceiver 242, a notification to the user device 204 requesting the vehicle user to park the vehicle 102 in an enclosed parking space.

Responsive to determining the optimal time as described above or responsive to determining that the software update may be available at the server 202, in some aspects, the processor 244 may transmit a user notification to the user device 204 indicating to the vehicle user that the software update is available for the vehicle 102. In some aspects, the user notification may include information associated with the determined optimal time. The user may view the user notification, and may confirm the notification if the user accepts the determined time for the OTA flash. In this case, the processor 244 may obtain a user confirmation from the user device 204 responsive to transmitting the user notification. Responsive to obtaining the user confirmation, the processor 244 may transmit (via the transceiver 242) an installation initiation notification to the server 202 to install the software update at the determined optimal time.

In some aspects, the user may select a different time for the OTA flash responsive to receiving the user notification on the user device 204, if the user does not accept the determined optimal time (e.g., if the user plans to use/drive the vehicle 102 at the determined optimal time). In further aspects, the processor 244 may skip this step of seeking/obtaining the user confirmation, and may directly transmit the installation initiation notification to the server 202 to install the software update at the optimal time, responsive to determining the optimal time.

The server 202 may transmit the software update file to the transceiver 242/processor 244, when the server 202 receives the installation initiation notification from the processor 244. The processor 244 may obtain the software update file from the server 202 responsive to transmitting the installation initiation notification, and may cause the vehicle 102 to install/execute the software update responsive to obtaining the software update file. It may be appreciated that depending on the size of the software update file, the OTA flash may take a few minutes to several minutes.

The processor 244 may further estimate/measure the first SOC drop in the battery 240 when the vehicle 102 installs/executes the software update or when the processor 244 performs the OTA flash. As described above in conjunction with FIG. 1, the first SOC drop may be associated with the battery drain or the drop in the battery SOC caused due to the execution/installation of the software update (or caused due to OTA flashing). In an exemplary aspect, the processor 244 may measure the first SOC drop based on the inputs obtained from the VCU 210, when the software update installation or OTA flash is complete. In this case, the processor 244 may obtain the inputs associated with real-time battery SOC pre and post OTA flash, and determine the first SOC drop as a difference between the post-OTA battery SOC and the pre-OTA battery SOC.

In another exemplary aspect, the processor 244 may estimate the first SOC drop based on “update information” associated with the software update. In this case, the processor 244 may obtain the update information from the server 202, one or more vehicle components (e.g., the TCU 226), other vehicles via vehicle-to-vehicle (V2V) communication, and/or the like. The update information may include, for example, information associated with a total size of the software update file, a transfer rate associated with the network 206, an initial battery SOC before the software update installation/OTA flash operation, battery health condition, battery age, and/or the like. The processor 244 may correlate the obtained update information with a data structure that includes a mapping of a plurality of battery SOC drop values with the different parameters included in the update information, to estimate the first SOC drop. The data structure described here may be pre-stored in the memory 246 and/or the server 202, or may be generated by the processor 244 itself by monitoring the battery SOC drop values over time when the vehicle 102 performs OTA flash, or may be generated/provided by the vehicle manufacturer.

In some aspects, the processor 244 may estimate the first SOC drop based on the update information described above pre-OTA flash operation or post-OTA flash operation. In an exemplary aspect, the processor 244 may estimate the first SOC drop based on the update information even before determining the optimal time. In this case, the processor 244 may estimate the first SOC drop based on the update information responsive to determining that the software update is available on the server 202, and may perform the step of determining the optimal step described above when the processor 244 determines that the first SOC drop may be greater than the predefined SOC drop threshold.

Responsive to estimating/measuring the first SOC drop by using one of the methods described above, the processor 244 may determine the expected vehicle engine start time based on a historical vehicle usage pattern (that may be part of the historical vehicle information) or based on a pre-stored user input that indicates when the user desires to drive the vehicle 102. As described above in conjunction with FIG. 1, the expected vehicle engine start time may be an estimated future time when the vehicle user is expected to crank or start the vehicle engine, e.g., to drive or use the vehicle 102. In some aspects, the processor 244 may determine the expected vehicle engine start time responsive to determining that the software update is available on the server 202. In other aspects, the processor 244 may determine the expected vehicle engine start time when the OTA flash is complete. Further, as described above in conjunction with FIG. 1, the processor 244 may determine the expected vehicle engine start time based on pre-programmed trip start time that the vehicle user may have provided to the vehicle 102 in advance. For example, if the user has provided an input to the vehicle 102 (e.g., to the vehicle's onboard computer) indicating that the user will start a trip at 7 AM, the processor 244 may determine the expected vehicle engine start time as 7 AM. In this case, the processor 244 may also customize/optimize the vehicle's cabin temperature/climate before the scheduled trip start time (i.e., by 7 AM).

Responsive to determining the expected vehicle engine start time, the processor 244 may obtain weather condition information (or weather information) associated with a geographical area where the vehicle 102 is located, from the server 202 or any cloud based computing entity that provides weather condition information. The processor 244 may further determine an estimated ambient temperature at the expected vehicle engine start time based on the obtained weather information. The processor 244 may then fetch the mapping of a plurality of battery SOC drop values or power drain values with a plurality of ambient temperatures from the memory 246. As described above, the mapping may include a table that has information associated with an expected SOC drop or power drop in the battery 240 due to cold weather at different ambient temperatures.

The processor 244 may correlate the estimated ambient temperature at the expected vehicle engine start time with the mapping to estimate the second SOC drop in the battery SOC at the expected vehicle engine start time. As described above, the second SOC drop may be indicative of the drop in the battery SOC/power due to cold ambient temperature. In some aspects, the second SOC drop may also depend on the battery age (and/or battery health). For example, if the battery 240 is old, the second SOC drop may be higher as compared to a second SOC drop for a relatively newer battery (in the same ambient condition/temperature).

In some aspects, the processor 244 may estimate the second SOC drop as described above when the vehicle is parked outside and not in an enclosed space. In this case, the processor 244 may first determine that the vehicle 102 is not parked in an enclosed space based on the inputs obtained from the vehicle sensory system 232, and may estimate the second SOC drop when the processor 244 determines that the vehicle 102 is not parked in an enclosed space. It may be appreciated that if the vehicle 102 is parked in an enclosed space, the vehicle 102 may not be exposed to cold ambient temperature and hence the battery 240 may not experience any substantial drop in the battery SOC due to the cold weather conditions (and hence the second SOC drop may be expected to be close to zero).

In additional or alternative aspects, the processor 244 may estimate the second SOC drop described above when the battery 240 may have experienced or is expected to experience a substantial first SOC drop. In this case, the processor 244 may first compare the first SOC drop with the predefined SOC drop threshold, and may estimate the second SOC drop when the processor 244 determines that the first SOC drop is greater than the predefined SOC drop threshold. It may be appreciated if the battery 240 has experienced or is expected to experience a substantial first SOC drop due to the OTA flash, any further battery SOC loss due to the cold ambient weather conditions may significantly enhance the chances of an unsuccessful vehicle engine crank when the user attempts to start the vehicle 102 (which may cause inconvenience to the user). To prevent such a scenario from happening, the processor 244 may estimate the second SOC drop when the first SOC drop may be substantial (or greater than the predefined SOC drop threshold).

Responsive to determining/estimating the first SOC drop and the second SOC drop as described above, the processor 244 may perform one or more post-OTA mitigation actions, to ensure that the vehicle 102 successfully cranks the vehicle engine when the user attempts to start the vehicle 102 at the expected vehicle engine start time. Specifically, responsive to determining/estimating the first SOC drop and the second SOC drop, the processor 244 may perform one or more post-OTA mitigation actions to ensure that the battery 240 has regained or replenished the “lost” energy/SOC (due to the OTA flash operation and the cold weather conditions) that may enable the battery 240 to successfully crank the vehicle engine when the user attempts to start the vehicle 102 at the expected vehicle engine start time. An example post-OTA mitigation action is described below.

In some aspects, the processor 244 may switch ON the vehicle engine within a predefined time duration of a completion of the software update installation/OTA flash (when the vehicle engine may still be warm), and cause the vehicle engine to remain in an ON state till the battery 240 is charged for an SOC value equivalent to the sum of the first SOC drop and the second SOC drop. The processor 244 may further control a vehicle actuator output to a high charge rate to top off the battery 240 or charge the battery 240 for the SOC value described above. This action may put back the same amount of charge/energy/SOC into the battery 240 that the battery 240 may have lost due to the OTA flash operation and the SOC that the battery 240 is expected to drain due to the cold weather conditions by the expected vehicle start time. As an example, if the battery 240 lost 15% SOC due to the OTA flash operation and is expected to effectively drain another 15% SOC/power by the expected vehicle start time due to the cold weather conditions, the processor 244 may switch ON the vehicle engine to charge the battery 240 by 30%. In this manner, the battery 240 may have more SOC than the pre-OTA SOC level, which may enable the battery 240 to successfully crank/start the vehicle engine at the expected vehicle start time.

It may be appreciated that restarting a warm vehicle engine post the OTA flash operation may result in less drain on the battery 240 and ensure a successful vehicle engine crank/start. The post-OTA flash battery charge operation, as described in the present disclosure, is more advantageous than a pre-OTA flash battery charge operation that is conventionally performed. This is because the post-OTA flash battery is more deterministic of the nature of the actual battery SOC drain, and hence is more accurate. Topping off or charging a battery prior to the OTA flash is less deterministic as the length of the OTA may vary and the SOC drain may vary with it.

Responsive to determining that the battery 240 is charged for the SOC value equivalent to the sum of the first SOC drop and the second SOC drop (based on the inputs obtained from the VCU 210), the processor 244 may switch OFF the vehicle engine. An example scenario depicting the processor 244 operation of performing the OTA flash and switching ON/ OFF the vehicle engine is depicted in FIG. 3.

FIG. 3 depicts an example graph 300 between time (shown in X-axis) and ambient temperature (shown in Y-axis). In the exemplary scenario depicted in FIG. 3, the user may park the vehicle 102 at a time “T1” when the ambient temperature may be 18 degrees Fahrenheit. Responsive to the user parking the vehicle 102 (or the vehicle 102 entering a “key-off” phase), the processor 244 may perform the OTA flash operation at a time “T2”, when the ambient temperature may be 15 degrees Fahrenheit. In some aspects, a difference between “T2” and “T 1” may be small, so that the vehicle engine may still be warm (e.g., with a vehicle engine coolant temperature of greater than 100 or 120 degrees Fahrenheit) from the vehicle's drive cycle prior to the time “T1”.

When the OTA flash is complete, the processor 244 may crank/start the vehicle engine at a time “T3”, which may be immediately after the OTA flash completion or within a small predefined time duration of the OTA flash completion. The processor 244 may keep the vehicle engine in the ON state till a time “T4”, by which the battery 240 may get charged by the SOC amount/value equivalent to the sum of the first SOC drop and the second SOC drop. The processor 244 may switch OFF the vehicle engine at the time “T4” when the battery 240 is charged, as described above.

The processor operation described above ensures that when the user starts the vehicle 102 at a time “T5” (which may be the expected vehicle start time, and when the ambient weather is expected to be cold), the battery 240 has enough charge/SOC to successfully crank the vehicle engine and the user does not face any inconvenience.

The processor 244 may perform one or more additional actions to optimize the vehicle performance. For example, when the vehicle 102 is parked inside an enclosed and closed garage when the processor 244 auto-starts or cranks the vehicle engine to replenish the battery SOC, the processor 244 may obtain inputs from the vehicle sensor system 232 to determine if the garage door is closed. Responsive to determining that the garage door is closed, the processor 244 may transmit a command signal to a garage door computing device to auto-open the garage door when the processor 244 starts the vehicle engine to replenish the battery SOC. Once the battery SOC is replenished, the processor 244 may switch off the vehicle engine and transmit a command signal to the garage door computing device to auto-close the garage door.

Further, although the description above is described in the context of the processor 244 replenishing the battery charge/SOC when the vehicle 102 is located in cold ambient temperature, the present disclosure is not limited to such an aspect. In additional aspects, the processor 244 may determine if vehicle 102 is going to be parked for an extended period of time in moderate climates (i.e., vacation mode/airport parking for a week or more) based on historical or deterministic vehicle information. It may be appreciated that batteries undergo parasitic power draws even when the vehicles are not driven. In this case as well, the processor 244 may auto-crank the vehicle engine to replenish the drained battery SOC, in the similar manner as described above.

Furthermore, although the description above is described in the context of the processor 244 replenishing the battery charge/SOC due to the OTA flash operation, the present disclosure is not limited to such an aspect. The processor 244 may perform a similar “battery replenishment” operation to compensate for the battery charge/energy loss due to post key-off diagnostics that the vehicle 102 typically performs after the user parks/switches OFF the vehicle 102. It may be appreciated that in most modern vehicles, post key-off diagnostics are performed to check the status of multiple vehicle components/modules (e.g., lights, windows, communication modules, etc.). Such post key-off diagnostics may drain battery energy/charge. The principles/details/processes of replenishing the battery charge/SOC, as described in the present disclosure, can be applied to compensate for the battery energy loss due to post key-off diagnostics as well, without departing from the present disclosure scope. In an exemplary aspect, the processor 244 may replenish the battery SOC drained due to key-off diagnostics if the drop in battery SOC may be greater than a threshold value. Further, in this case, the processor 244 may replenish the battery SOC when the battery 240 may be aged and/or when the vehicle 102 may be located in cold ambient environment or parked for a long duration of time.

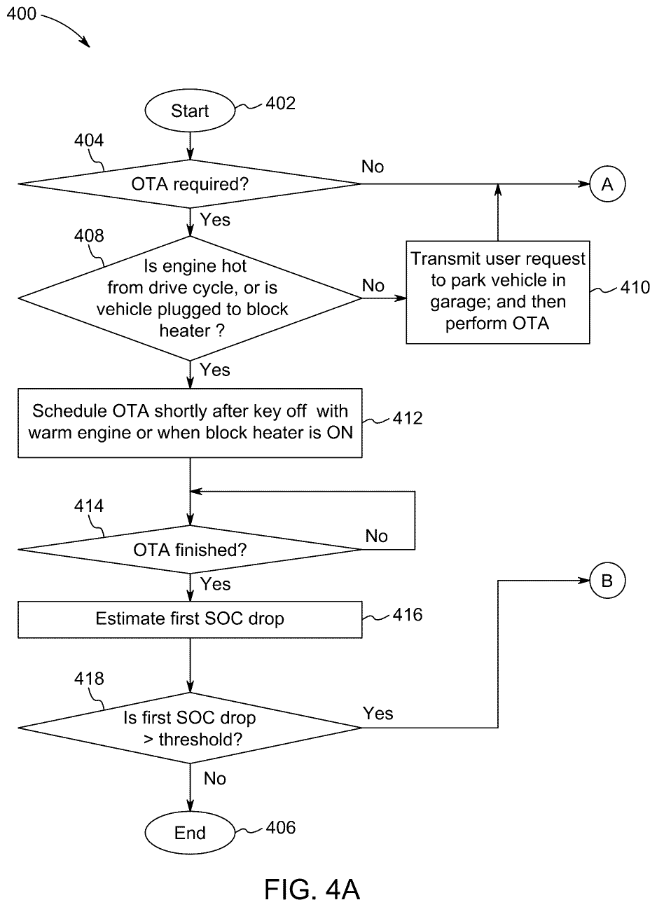

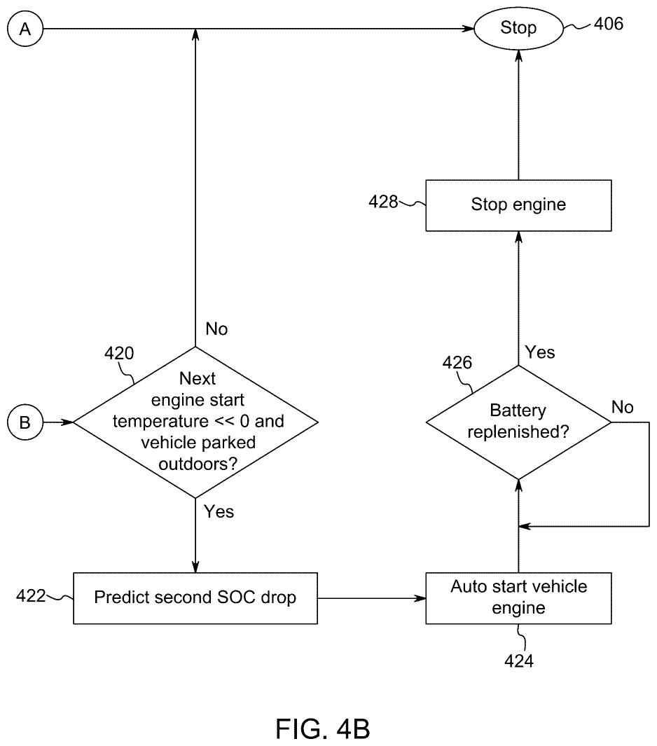

FIGS. 4A and 4B depict a flow diagram of an example method 400 to install an OTA update on the vehicle 102 in accordance with the present disclosure. FIGS. 4A and 4B may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include determining, by the processor 244, whether the OTA is required. Stated another way, at the step 404, the processor 244 may determine whether the software update is available on the server 202 for the vehicle 102. If no software update is available, the method 400 may move to step 406, at which the method 400 may end.

On the other hand, when the processor 244 determines that the OTA is required at the step 404, the method 400 may move to step 408, at which the processor 244 may determine whether the vehicle engine is hot from a drive cycle or whether the vehicle 102 is connected to a block heater. In some aspects, the processor 244 may perform the step 408 at the optimal time described above. In other aspects, the processor 244 may perform the step 408 whenever the processor 244 determines that the OTA is required.

The method 400 may move to step 410 when the processor 244 determines that the vehicle engine is not hot and the vehicle 102 is not connected to a block heater. At the step 410, the processor 244 may transmit a user notification to the user device 204, requesting the user to park the vehicle 102 in an enclosed space. Responsive to the user parking the vehicle 102 in the enclosed space, the processor 244 may perform the OTA flash. The method 400 may then move to the step 406.

On the other hand, the method 400 may move to step 412 when the processor 244 determines that the vehicle engine is hot or the vehicle 102 is connected to a block heater at the step 408. At the step 412, the processor 244 may schedule/execute the OTA flash shortly (or within a short predefined time duration) after the vehicle key-off when the engine may still be warm or when the vehicle 102 may be connected to the block heater. The processor 244 may then continuously check/monitor if the OTA flash operation is finished at step 414.

When the OTA flash operation is complete, then at step 416, the processor 244 may measure/estimate the first SOC drop, as described above. At step 418, the processor 244 may determine whether the first SOC drop is greater than the predefined SOC threshold. The method 400 may move to the step 406 when the processor 244 determines at the step 418 that the first SOC drop is less than the predefined SOC threshold.

On the other hand, responsive to determining that the first SOC drop is greater than the predefined SOC threshold at the step 418, the processor 244 may determine whether the estimated ambient temperature at the expected vehicle engine start time is less than 0 degrees Fahrenheit (or any other predefined temperature threshold) and the vehicle 102 is parked outside (i.e., not in an enclosed space) at step 420. If any of these conditions is not met, the method 400 may move to the step 406.

On the other hand, responsive to determining that the estimated ambient temperature at the expected vehicle engine start time is less than 0 degrees and the vehicle 102 is parked outside, the method 400 may move to step 422. At the step 422, the processor 244 may estimate/ predict the second SOC drop, as described above. At step 424, the processor 244 may auto-start the warm vehicle engine. At step 426, the processor 244 may continuously monitor whether the battery 240 is replenished with an SOC amount equivalent to the sum of the first SOC drop and the second SOC drop.

At step 428, the processor 244 may stop the vehicle engine when the battery 240 is replenished. The method 400 may move to the step 406 after the step 428, at which the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a battery configured to provide power to the vehicle;
a memory configured to store a historical vehicle information; and
a processor configured to:
determine that a software update is available for the vehicle;
determine, based on the historical vehicle information, an optimal time to initiate a software update installation in the vehicle to optimize a battery usage, responsive to determining that the software update is available; and
transmit an installation initiation notification to a server to install the software update at the optimal time.

2. The vehicle of claim 1, wherein the historical vehicle information comprises at least one of an information associated with time durations when a vehicle engine likely has residual heat from vehicle's travel cycles, an information associated with time durations when the vehicle is likely connected with a block heater, or an information associated with time durations when the vehicle is likely parked in an enclosed parking space.

3. The vehicle of claim 2, wherein the optimal time is within at least one of the time durations when the vehicle engine likely has residual heat from vehicle's travel cycles, the time durations when the vehicle is likely connected with the block heater, or the time durations when the vehicle is likely parked in the enclosed parking space.

4. The vehicle of claim 1 further comprising a sensory system configured to provide inputs to the processor, wherein the processor is further configured to:
monitor a vehicle engine coolant temperature based on inputs obtained from the sensory system;
compare the vehicle engine coolant temperature with a predefined coolant temperature threshold; and
determine the optimal time to initiate the software update installation as a time when the vehicle engine coolant temperature becomes greater than the predefined coolant temperature threshold.

5. The vehicle of claim 1, wherein the processor is further configured to transmit a notification to a user device requesting a vehicle user to park the vehicle in an enclosed parking space when the processor is unable to determine the optimal time based on the historical vehicle information.

6. The vehicle of claim 1, wherein the processor is further configured to:
obtain the software update from the server responsive to transmitting the installation initiation notification;
cause the vehicle to install the software update responsive to obtaining the software update; and
estimate a first drop in a battery state of charge (SOC) when the vehicle installs the software update.

7. The vehicle of claim 6, wherein the processor is further configured to:
obtain an update information associated with the software update responsive to determining that the software update is available; and
estimate the first drop based on the update information.

8. The vehicle of claim 7, wherein the update information comprises an information associated with one or more of: a total size of a software update file, a transfer rate associated with a wireless network connection between the vehicle and the server, an initial battery SOC before the software update installation, and a battery age.

9. The vehicle of claim 6 further comprising a vehicle control unit configured to provide inputs to the processor, wherein the processor is further configured to estimate the first drop based on inputs obtained from the vehicle control unit when the software update installation is complete.

10. The vehicle of claim 6, wherein the memory is further configured to store a mapping of a plurality of battery SOC drop values with a plurality of ambient temperatures, and wherein the processor is further configured to:
determine an expected vehicle engine start time based on a historical vehicle usage pattern responsive to determining that the software update is available;
determine an estimated ambient temperature at the expected vehicle engine start time based on a weather information;
correlate the estimated ambient temperature with the mapping; and
estimate a second drop in the battery SOC at the expected vehicle engine start time based on the correlation.

11. The vehicle of claim 10, wherein the processor is further configured to determine that the vehicle is not parked in an enclosed space, and wherein the processor estimates the second drop when the processor determines that the vehicle is not parked in the enclosed space.

12. The vehicle of claim 10, wherein the processor is further configured to compare the first drop with a predefined SOC drop threshold, and wherein the processor estimates the second drop when the processor determines that the first drop is greater than the predefined SOC drop threshold.

13. The vehicle of claim 10, wherein the processor is further configured to:
switch ON a vehicle engine within a predefined time duration of a completion of the software update installation, responsive to estimating the first drop and the second drop; and
cause the vehicle engine to remain in an ON state till the battery is charged for an SOC value equivalent to a sum of the first drop and the second drop.

14. The vehicle of claim 13, wherein the processor is further configured to:
determine that the battery is charged for the SOC value equivalent to the sum of the first drop and the second drop; and
switch OFF the vehicle engine when the battery is charged for the SOC value equivalent to the sum of the first drop and the second drop.

15. The vehicle of claim 1, wherein the processor is further configured to:
transmit a user notification to a user device indicating that the software update is available; and
obtain a user confirmation from the user device responsive to transmitting the user notification; and
transmit the installation initiation notification to the server responsive to obtaining the user confirmation.

16. A method comprising:
determining, by a processor, that a software update is available for a vehicle;
determining, by the processor and based on a historical vehicle information, an optimal time to initiate a software update installation in the vehicle to optimize a vehicle battery usage, responsive to determining that the software update is available; and
transmitting, by the processor, an installation initiation notification to a server to install the software update at the optimal time.

17. The method of claim 16, wherein the historical vehicle information comprises at least one of an information associated with time durations when a vehicle engine likely has residual heat from vehicle's travel cycles, an information associated with time durations when the vehicle is likely connected with a block heater, or an information associated with time durations when the vehicle is likely parked in an enclosed parking space.

18. The method of claim 16 further comprising:
obtaining the software update from the server responsive to transmitting the installation initiation notification;
causing the vehicle to install the software update responsive to obtaining the software update;
estimating a first drop in a battery state of charge (SOC) when the vehicle installs the software update;
determining an expected vehicle engine start time based on a historical vehicle usage pattern responsive to determining that the software update is available;
determining an estimated ambient temperature at the expected vehicle engine start time based on a weather information;
correlating the estimated ambient temperature with a mapping of a plurality of battery SOC drop values with a plurality of ambient temperatures; and
estimating a second drop in the battery SOC at the expected vehicle engine start time based on the correlation.

19. The method of claim 18 further comprising:
switching ON a vehicle engine within a predefined time duration of a completion of the software update installation, responsive to estimating the first drop and the second drop; and
causing the vehicle engine to remain in an ON state till the battery is charged for an SOC value equivalent to a sum of the first drop and the second drop.

20. A non-transitory computer-readable storage medium having instructions stored thereupon which, when executed by a processor, cause the processor to:
determine that a software update is available for a vehicle;
determine, based on a historical vehicle information, an optimal time to initiate a software update installation in the vehicle to optimize a vehicle battery usage, responsive to determining that the software update is available; and
transmit an installation initiation notification to a server to install the software update at the optimal time.
